(19) United States
(12) Patent Application Publication
(10) Pub. No.: US 2025/0091247 A1
(43) Pub. Date: Mar. 20, 2025

(54) A PRODUCTION METHOD, AND A CERAMIC PRODUCT OBTAINED BY SUCH METHOD

(71) Applicant: RELIEFED AB, Varberg (SE)

(72) Inventor: Mark J. KRAGH, Varberg (SE)

(21) Appl. No.: 18/729,252

(22) PCT Filed: Jan. 31, 2023
(86) PCT No.: PCT/EP2023/052299

§ 371 Date: Jul. 16, 2024

(30) Foreign Application Priority Data
Jan. 31, 2022 (SE) 2250089-6

(51) Int. Cl. B28B 3/26; B28B 3/12

(52) U.S. Cl. CPC B28B 3/26; B28B 3/12

(57) ABSTRACT

A production method is provided. The production method comprises forming material by pressing or pulling ceramic material through a channel of an extrusion die, said channel being at least partly defined by the lateral surface area of at least one rotating die, and heat processing the formed material to form a ceramic product.

### TECHNICAL FIELD

The present invention relates to a production method for manufacturing ceramic products, and to ceramic products produced by such method.

### BACKGROUND

Ceramic products are vastly used for various applications. One common ceramic product application is structural components, such as bricks, pipes, and wall and floor tiles for interior and exterior decoration. Production of such tiles involves a number of steps. The raw materials, including clay minerals, are prepared by mixing and grinding, and optionally drying. A forming step is thereafter performed. One available forming method is based on dry pressing, where powder material is arranged and compressed in a forming die. Another option requires wetter raw materials, and allows forming of the ceramic product by extrusion and subsequent punching.

Once the article is formed to its desired shape it is normally subject to a post-forming process including drying, glazing and firing.

Existing manufacturing methods for ceramic products require certain properties of the raw materials, and the designs of the final products are limited by the capabilities of the existing production equipment. Typically, if there is need for new ceramic products with new designs there is a large risk that these cannot be made by existing manufacturing processes, thus requiring expensive and time consuming post-processing and process adaptations.

Hence, there is need for an improved manufacturing processes which not only provides a more versatile approach to the production of ceramic products, but also reduces cost and time for ceramic product production.

### SUMMARY

It is an object of the invention to at least partly overcome one or more of the above-identified limitations of the prior art. In particular, it is an object to provide a manufacturing method where the raw material is continuously formed, and which forming allows for the creating of advanced pattern and structures to the final ceramic product.

To solve these objects a production method is provided, comprising i) forming material by pressing or pulling ceramic material through a channel of an extrusion die, said channel being at least partly defined by the lateral surface area of at least one rotating die, and ii) heat processing the formed material to form a ceramic product.

Preferably, the method is performed by pressing or pulling the ceramic material through bearing surfaces defining the channel. The channel is preferably formed by an extrusion die, whereby the bearing surfaces comprise at least one rotating bearing surface being a surface of a rotating die that defines the cross-section of the formed material such that the channel being at least partly defined by the at least one rotating die.

The rotating die may apply a pattern to the formed material. Preferably, the applied pattern is a repetitive pattern.

The method may further comprise a step of shrinking the formed material such that the dimensions of the pattern of the rotating die are different from the dimensions of the pattern of the ceramic product. Preferably, this shrinking is performed during the heat processing.

The method may further comprise a step of adjusting the flow of the ceramic material upstream the channel. This allows for the control of a correct flow distribution and uniform speed of the ceramic material when it enters the channel.

The method may further comprise a step of driving said rotating die. Such driving may be performed continuously during the manufacturing method.

Driving the rotating die may further comprise synchronizing the rotation of the rotating die with the speed of a downstream conveyor for the ceramic product.

The method may further comprise a step of determining at least one dimension of the ceramic product, and adjusting speed of the rotating die and/or the downstream conveyor based on the determined dimension(s).

The step of heat processing may be performed by firing the formed material. Optionally, heat processing may be a multi-step process also comprising an initial drying step. Typically, such drying step is performed at a temperature which is significantly lower than the temperature of the firing.

The method may further comprise separating an individual product from the formed material before, during, or after heat processing. It should be noted that the steps of separating and heat processing can be performed in any order.

In an embodiment the method further comprises mounting a plurality of individual products to each other before the step of heat processing. By arranging multiple individual products in contact with each other during the heat processing, these will bond mechanically and form a uniform product.

Separating an individual product may be performed by a cutting action of the rotating die. This provides for efficient separation not requiring additional components and cutting or punching stations.

The circumference of the rotating die may be equal to the length of the individual product, or different from the length of the individual product. It is thus possible to determine the periodical match of the pattern of the rotating die with the final individual products in a very flexible manner.

The channel may have a longitudinal extension in a production direction, and the rotational axis of the rotating die may be arranged at an angle relative to said production direction, preferably the rotating die is arranged at an angle of 90°±25° relative to said production direction. It is thus not only possible to have the rotating die perfectly transverse to the production direction, but also to allow the rotating die to “screw” over the material to be formed.

The channel may be defined by a bottom area, an upper area, and two opposing side areas together forming a closed space, wherein at least a part of one of the areas may be formed by the lateral surface area of the at least one rotating die.

In some embodiments, at least a part of at least one further area is defined by the lateral surface area of a further rotating die.

At least one of the bottom area, upper area, and the two opposing side areas may be defined by a bearing surface.

The manufacturing method thus allows for the use of one or more (two, three, four, five, etc.) rotating dies to provide a repetitive pattern to the material to be formed.

The method may further comprise pressing or pulling ceramic material through a pre-bearing passage arranged upstream the rotating die.

The pre-bearing passage may be arranged immediately upstream the rotating die, or the pre-bearing passage may be arranged upstream, but remote from, the rotating die.

The pre-bearing passage may be configured to deform the ceramic material into a master profile, while the channel may be configured to further deform the material into a final profile having a final shape.

The dimensions of the pre-bearing passage may be static.

The lateral surface area of the rotating die may be provided with a topographic pattern. Said topographic pattern may comprise at least one protrusion, said protrusion being configured to form a separation notch in the ceramic product and/or a significant local reduction of the thickness of the ceramic product.

Such significant reduction of the thickness of the ceramic product may define a removable portion of the ceramic product. Due to the thickness reduction it is possible to allow these removable portions to only require a very small force to actually be removed.

At least one protrusion may extend across the entire width of the rotating die, or across a part of the width of the rotating die. The protrusion may extend in a linear or curved manner across the width of the rotating die.

The method may further comprise adding a further material to the ceramic material. Adding such further material may be performed before, during, or after the ceramic material passes the rotating die.

The further material may be embedded in the ceramic material to form a reinforcement of the extruded article.

The further material may be a fibre material or a web material.

The further material may be added as at least one layer to the ceramic material.

The further material may be a liquid or a solid material in the form or powder or particles.

The further material may comprise a plurality of different ceramic and/or non-ceramic materials.

The ceramic material and the at least one further material may be fed through the channel.

The method may further comprise adjusting the position of the rotating die thereby adjusting the dimensions of the channel.

The method may further comprise providing the channel with at least one die core, said die core forming a hollow portion of said ceramic product.

The ceramic product may be a brick or a plate-like product such as a tile.

The channel may provide one side of the formed material with a first structural surface pattern defined by the lateral surface area of at least one rotating die, and an opposite side of the formed material with a second structural surface pattern defined by the lateral surface area of another rotating die.

The first and second structural surface patterns may provide a matching fit when multiple ceramic products are stacked onto each other.

According to a second aspect a ceramic product is provided. The ceramic product is formed by forming ceramic material by pressing or pulling the ceramic material through a channel at least partly defined by at least one rotating die, and subsequent heat processing to form the ceramic product.

Preferably, the ceramic product is formed by pressing or pulling the ceramic material through bearing surfaces defining the channel. The channel is preferably formed by an extrusion die, whereby the bearing surfaces comprise at least one rotating bearing surface being a surface of a rotating die that defines the cross-section of the formed material such that the channel being at least partly defined by the at least one rotating die.

The ceramic product may be a brick or a plate-like product such as a tile or cladding.

Said ceramic product may comprise a plurality of sides, wherein each side is provided with a contour which matches with a corresponding contour of a side of another ceramic product.

The ceramic product may comprise a structural surface pattern corresponding to a pattern of the rotating die.

The structural surface pattern may be provided on an upper side of the ceramic product during its intended use.

The ceramic product may further comprise a structural surface pattern on a bottom side of the ceramic product during its intended use.

The structural surface pattern on the bottom side of the ceramic product may form mounting structures for the ceramic product.

The respective structural surface patterns may provide a fit when multiple ceramic products are stacked onto each other.

The ceramic product may comprise at least one further material.

According to a third aspect a device is provided, comprising at least one ceramic product according to the second aspect.

The device may be a thermal device and the ceramic product may form part of a heat exchanger, cooling profile, and/or heat element.

The device may be a chemical reactor and the ceramic product may form part of a catalyser or condenser.

The device may be an anti-slip device and the ceramic product may form a surface of said anti-slip device.

Still other objectives, features, aspects and advantages of the invention will appear from the following detailed description as well as from the drawings.

Within this specification some specific terms are used, which are defined in the following.

Extrusion: Procedure in which a material under pressure is pressed through a profile shaping tool (also called die) with hole(s) that defines the outgoing materials cross-section and appearance.

Pultrusion: Procedure in which a material under pressure is pulled through a profile shaping tool (also called die) with hole(s) that defines the outgoing materials cross-section and appearance.

Dynamic extrusion: Procedure in which a material under pressure is pressed through a tool with rotating forming members (dies) that can give the material a diverse cross-section and/or appearance in the form of e.g. patterns on one or more surfaces and dimensional changes in cross-sectional area and/or material thickness.

Dynamic pultrusion: Procedure in which a material under pressure is pulled through a tool with rotating forming members (dies) that can give the material a diverse cross-section and/or appearance in the form of e.g. patterns on one or more surfaces and dimensional changes in cross-sectional area and/or material thickness.

Die: Generally, the name used by professionals for profile forming tools.

Rotating die: Rotating profile-shaping part of the tool for dynamic extrusion/pultrusion.

Bearing surface: The surface of an extrusion die in the smallest cross-section that the extruded material is forced through under pressure and thus constitutes the surface to finally define the cross-section and appearance of the formed material.

Static bearing surface: A solid bearing surface the extruded material is forced to pass at a relative speed of outgoing material speed. Because it is static, there is a speed difference between the static bearing surface and the extruded material, resulting in friction and heat. By regulating the length of the bearing surfaces it is possible to regulate the total amount of friction and thus the pressure, balance, and speed of the outgoing material.

Rotating bearing surface: A rotating bearing surface is a surface of the rotating die that defines the cross-section of the formed material, allowing for pattern generation as well as material thickness variations. A rotating bearing surface in general generates much less resistance and friction against the flowing material than a static bearing surface, which previously has created major problems with the imbalance between the different parts of the cross-section of the formed material, and which is defined by all bearing surfaces of the entire die. This has often resulted in process breakdown at start up.

Pre-bearing (surface): The surface area that the extruded material passes before, preferably immediately before, it enters the area of the rotating die and its rotating bearing surface. The pre-bearing brings down the material cross-section so much so that the subsequent rotating die won't have to take up unnecessarily large forces from the formed material. Pre-bearing has in combination with upstream material shaping a central role for control and/or regulation of material flows through the die.

Dynamic extrusion and dynamic pultrusion: The process of forming (ceramic) material by utilising rotating dies integrated in extrusion dies. The extrusion die has one or more rotational dies. The cross-sectional profile of the formed material may optionally be defined upstream of where the material to be formed reaches the rotating die whose outer circumference, i.e. the lateral surface area, defines a rotating bearing surface that finally defines the appearance and cross-section of the formed material in conjunction with other bearing surfaces, rotating and/or static, in the die.

Ceramic material: Within the context of this specification this term is to be interpreted broadly, covering any material that is suitable for forming a ceramic product. Ceramic material comprises any formable inorganic, non-metallic oxide, nitride, or carbide material which, after heat processing preferably causing vitrification at least to some extent, forms a hard, brittle, heat resistant and corrosion resistant ceramic product. While no specific list of compounds or minerals are given here, general properties of ceramic products comprise high melting temperature, high hardness, poor conductivity, high moduli of elasticity, high chemical resistance, and low ductility. Examples of ceramic material include clay minerals such as kaolinite, alumina, and silicon carbide.

Pattern: Any structural configuration being transferrable from a die to a ceramic material. A pattern may be macroscopic, i.e. visible by the human eye, or microscopic. A pattern may further extend across the entire formed material, or across only a very small part of it. Typically, although not required, a pattern is a topographic configuration. Examples of patterns comprised within the context of this specification are thickness variations of the formed material, reinforcement ribs, channels, and macro as well as micro structures. Even an entirely smooth surface is herein considered to define a pattern.

### BRIEF DESCRIPTION OF THE DRAWINGS

Embodiments of the invention will now be described, by way of example, with reference to the accompanying schematic drawings, in which

FIG. 1 is a schematic view of equipment for producing ceramic products according to an embodiment;

FIG. 2 schematically shows a cross-sectional perspective side view of a device configured to perform at least a part of a method according to the invention, with ceramic material being processed;

FIG. 3 schematically shows a side view, in cross-section, of the device of FIG. 2 according to one example;

FIG. 4 schematically shows an isometric view of parts of device configured to perform at least a part of a method according to the invention;

FIGS. 5 to 10 schematically shows a side view, in cross-section, of the device of FIG. 2 according to one example;

FIGS. 11 and 12 show examples of ceramic products according to different embodiments; and

FIG. 13 is a schematic flowchart of a manufacturing method according to various embodiments.

### DETAILED DESCRIPTION

Extrusion of ceramic materials is not trivial. Many ceramic materials are very difficult to extrude due to high friction between the extruded material and the bearing surface. This high friction causes slow production speed, and the general approach to address this problem is to add solid or fluid lubricants to the ceramic material. Such lubricants include polyetylen or polypropen when extruding e.g. silicon nitride, and/or liquid lubricants such as water, oil, or other evaporable or combustible lubricant.

The present invention is based on the principle of extruding a ceramic material using at least one rotating die, thus forming a rotating bearing surface. The inventors have surprisingly realized that using this technique, the friction that cause the internal shear in the formed material (i.e. by the friction between the extruded material and the bearing surfaces) is to a large extent eliminated. As the friction is significantly reduced, a number of advantages follow.

First of all, the present invention allows for faster extrusion of ceramic material. Secondly, the present invention makes it possible to reduce the liquid (i.e. water, solvent, and/or lubricant) content of the ceramic material while still obtaining the desired production speed. This also reduces the required cost and time for drying the ceramic material after forming, thereby increasing the throughput of the production method.

As the liquid content can be reduced this leads to additional advantages; the formed material will be more rigid and robust, which leads to possibilities of extruding geometries not possible with the prior art methods. Also, due to less liquid content there will less cost for solvent and/or lubricants, and also less shrinkage of the final ceramic product which makes it easier to design the final ceramic product.

The present invention has also proven to significantly improve the surface quality of the extruded ceramic material. This in turn makes it possible to extrude thinner material and to extrude ceramic material previously not being suitable for extrusion, such as ceramic material containing large solid particles, or ceramic material causing a specifically high friction.

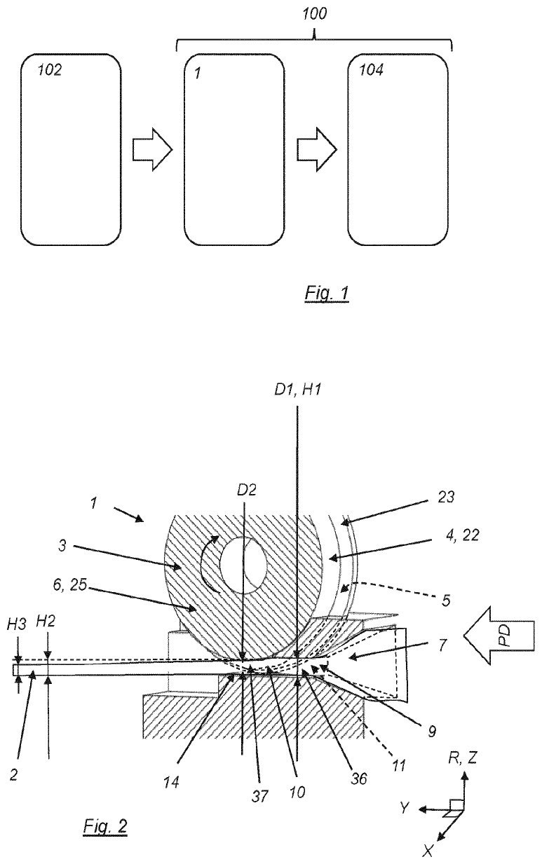

Now starting in FIG. 1, equipment 100 for performing the method of the present invention is schematically shown. The equipment 100 requires a supply 102 of ceramic raw material. During operation of the equipment this ceramic material is supplied to an extrusion device 1 which processes the ceramic material and forms it to a desired shape. After forming the ceramic material it is transported to a heat processing station 104, typically comprising driers, kilns, etc. for producing ceramic products from the formed ceramic material. Normally, heat processing comprises exposing the formed material to a temperature of 800° C. or more. The specific heat exposure (i.e. temperature, time, and gradient) is dependent on the particular material as well as the dimensions of the final ceramic product.

It should be noted that the equipment 100 schematically shown in FIG. 1 could be further provided with conveyors, feeders, etc. (not shown).

The extrusion device 1 used for forming the ceramic material will be explained in detail with reference to FIGS. 2 to 10.

Starting in FIG. 2, the device 1 is configured to process (i.e. form) ceramic material in a production direction PD. The ceramic material is a plastically deformable material and/or a viscoelastic material and/or a plastically deformable material with elastic property and/or a viscoplastic material with elastic property.

The device 1 comprises a rotating die 3, extending in a radial R direction and a width direction X, having two opposite first and second side walls 5, 6 and an outer circumferential (lateral) surface area 4 extending in the width direction X between the side walls 5, 6. The rotating die 3 comprises a first side portion 23 in connection to the first side wall 5 and a second side portion 25 in connection to the second side wall 6, and a mid-portion 22 extending between the first and second side portions 23, 25.

The device 1 further comprises a material definition zone 7 having a longitudinal direction Y coinciding with the production direction PD, a height direction Z and a width direction X being perpendicular to the height direction Z. The material definition zone 7 comprises a channel 10. In the device 1 shown in FIG. 1, the channel 10 is preceded (in the production direction PD) by a passage 9.

The passage 9 is circumferentially delimited by one or more walls 11 to form a closed circumference for the ceramic material. The channel 10, arranged immediately downstream the passage 9, is at least partly defined by the lateral surface area 4 of the rotating die 3. In the shown example the channel 10 is further defined by a counter-bearing 14, arranged opposite the rotating die 3, and opposing first and second channel portion side walls extending between the rotating die 3 and the counter-bearing 14.

Rotating die 3 is rotatable about an axis extending across the production direction PD and arranged to allow the lateral surface area 4 to, while the rotating die 3 rotates, exert a pressure onto a surface of the ceramic material when fed through the material definition zone 7.

According to the embodiment shown in FIG. 2, the passage 9 is configured to deform the ceramic material into a master profile 36 having a maximum height H1 at a predetermined feeding rate dependent on the ceramic material and minimum cross-sectional area with a first maximum height D1 when exiting the passage 9.

The channel 10 is configured to further deform the ceramic material into a final shape 37 having a minimum height H2 by the rotating die 3 being configured to apply increasing pressure on the master profile 36 against the counter-bearing 14. For this, the rotating die 3 is configured at a minimum distance D2 from the counter bearing 14 dependent on a maximum allowable pressure applied by the rotating die 3 at the position of that minimum distance D2. The maximum allowable pressure corresponds to the maximum difference in height of the master profile 36 and the final profile 37 and depending on a specific pattern on the lateral surface area 4 of the rotating die 3. The maximum allowable pressure is also dependent on the viscoelastic and viscoplastic properties of the ceramic material and thus a difference between the final height H3 of the formed material and the height H2 immediately after the channel 10, due to the elasticity of the material.

According to one example, the passage 9 is formed between at least two side walls 11; a top pre-bearing and an opposing bottom pre-bearing, wherein the top pre-bearing is arranged above the opposing bottom pre-bearing in the height direction Z. The top pre-bearing and/or the bottom pre-bearing may comprise a wake element.

Typically, the wake element protrudes in a direction from the side wall into the passage 9. According to one example, the wake element protrudes in the height direction from the side wall into the passage. The wake element can be designed depending on ceramic material elasticity giving the correct height of the master profile when entering the channel 10. Here, elasticity refers to the material swelling after having been pressed into shape in the passage 9. The wake element creates a wave form in the ceramic material when having passed the wake element

One advantage of the device 1 is that maximum load is controlled in both the passage 9 and in the channel 10 which gives the possibility to design the extrusion device 1 dependent on the ceramic material to be processed, as well as on the desired process speed. Controlling the maximum load dependent on ceramic material to be processed allows for a production rate with high quality output and reduces risk for e.g. rupture due to a too high stress on the ceramic material.

According to the example shown in FIG. 2, the extrusion device 1 receives ceramic material; this ceramic material is formed in the passage 9 into the shape of a master profile 36 and directly thereafter the ceramic material is formed in the channel 10 into the shape of the final profile 37. FIG. 2 also shows that the final profile 37 has a lesser height H1 than the height H2 of the master profile 36 due to further pressure on the master profile 36 in the channel 10. FIG. 2 also shows that the formed material 2 may have a lesser height H3 than the height H1 of the final profile 36 due to shrinking when cooling down from the final profile 37 to the product profile 2, if the forming is performed at elevated temperatures.

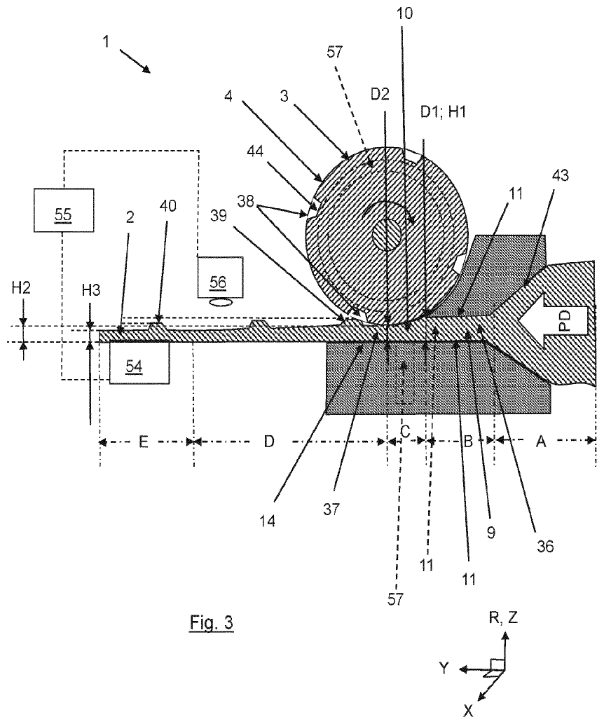

FIG. 3 schematically shows a cross-sectional side view of an extrusion device 1 according to an embodiment. Here, the rotating die 3 is shown in a rotational position where the part of the rotating die 3 pressing against the ceramic material against the counter-bearing 14 does not comprise any local pattern or indentation 38.

FIG. 3 schematically shows an initial zone A where the ceramic material is pressed by a device (not shown) into the passage 9 either by a device (not shown) exerting an external pressure in the production direction PD, i.e. extrusion, and/or by the ceramic material being dragged through the passage 9 by a device (not shown) dragging the material in the production direction PD, i.e. pultrusion.

Zone A of the device 1 comprises a funnel shaped opening 43 where the ceramic material changes from an initial form having a larger cross-section than the passage 9. The shape of the opening can, however, vary depending on the type of ceramic material, temperature and device pressing the material.

A zone B is arranged directly after zone A, wherein zone B corresponds to the longitudinal extension of the passage 9 and where the formation of the master profile 36 takes place, as a result of the ceramic material changing form due to the pressure exerted on the ceramic material from the side walls 11 of the passage 9 when the ceramic material moves through the passage 9.

A zone C is arranged directly after zone B, wherein zone C corresponds to the longitudinal extension of the channel 10 and where the formation of the final profile 36 takes place, as a result of the ceramic material changing form due to the pressure exerted on the ceramic material from at least the rotating die 3 and the opposing counter bearing 14 of the channel 10.

A zone D is arranged directly after zone C, wherein zone D corresponds to a section of the production line after channel 10 and where the ceramic material optionally starts to cool down (if the extrusion process is performed using elevated temperature). In such case the final profile 36 starts to change form due to shrinking as a consequence of the temperature drop. It should be noted that shrinkage can also occur due to drying of the formed material. In zone D, the final profile 37 can be subject to various production measures for achieving desired properties of the formed material, such as cooling, heating, stretching, compressing, etc. in order to change the final profile 37 into a desired shape with desired material properties.

The length of zone D typically depends on material properties and a working environment surrounding the ceramic material in zone D. The material properties are e.g. heat dissipation and the mass of the ceramic material to be cooled down. For example, a thinner material cools down faster than a thicker material. The working environment refers e.g. to ambient temperature and humidity. For example, a warmer environment slows down the cooling process compared to a cooler environment.

A zone E is arranged directly after zone D, wherein zone E corresponds to a section of the production line where the ceramic material has dried or has cooled down to a predetermined temperature representing a temperature establishing the final form of the formed material and where no, or only an infinitesimal change of form will continue. The formed material has a height H3 in zone E being optionally less than the height H2 of the final profile 37. In the same manner, the pattern 39 of the final profile 37 may shrink to a pattern 40 in zone E due to the drying/evaporation cooling.

For example, the method may be used with a ceramic material that will shrink in the range of 0-50%, such as between 0 and 20%. The shrinkage process may occur during any of the steps of cooling, drying, or heat processing (e.g. firing and/or glazing).

It should be noted that for some ceramic materials it is possible to run the extrusion device 1 at room temperature, whereby little or no cooling is needed and where the majority of the shrinkage that is taking place in general as a result of drying and heat processing. Zones D and E will in such embodiment be very short, if at all necessary.

In FIG. 3 the extrusion device 1 comprises a pulling and stretching device 54 arranged downstream the channel 10 and being configured to pull the ceramic material in the production direction PD when exiting the channel 10. One advantage is that the pulling and stretching device 54 dynamically can stretch the ceramic material during its forming, e.g. in order to obtain an equidistant pattern in the production direction PD of the formed material. The pulling and stretching device 54 can further be used to guide the formed material in the width and/or height direction.

According to one example, the distance between indentations 38 in the pattern 38 on the rotating die 3 is less than a distance between elevations 40 in the corresponding pattern 38 in the production direction PD on the formed material 2, wherein the pulling and stretching device 54 is configured to stretch the formed material so that high precision in distance between features on the formed material can be achieved by adjustment stretching.

The pulling and stretching device 54 can be any type of device that comprises means for gripping the formed material and means for pulling. According to one example, the pulling and stretching device 54 comprises controlling means 55 for controlling the pulling force applied to the formed material. The controlling means 55 may comprise sensor(s) and/or may be connected to sensor(s) 56 that supervises the state of the formed material. The sensor(s) comprises means for sending analog and/or digital information to the controlling means. The information relates to the state of the formed material and the controlling means 55 is configured to process the information for controlling the pulling and stretching device.

In one embodiment the rotating die 3 and/or the counter-bearing 14 comprises a cooling device 57 that cools down the ceramic material during forming. This has the advantage that a predetermined temperature of the ceramic material is achieved for optimum material properties of the formed material. The material temperature when extruding and/or pultruding can for certain ceramic materials be crucial for the quality of the final ceramic product. The temperature is also important due to frictional properties between the ceramic material and the rotating die 3 and/or the counter-bearing 14. The cooling device 57 can, for example, be arranged in the form of cooling circuits with gas or liquid fluid conductors arranged within the rotating die 3 and/or the counter-bearing 14; and/or external devices cooling down the rotating die 3 and/or the counter-bearing 14; and/or liquids or gaseous fluids added to the rotating die 3 and/or the counter-bearing 14, or a combination of such devices or any other suitable cooling devices. It should be noted that the rotating die 3 can be configured to operate without the cooling device 57.

According to one example, the rotating die 3 is configured to be cooled on the surface so that the temperature of the lateral surface area of the rotating die 3 is below a predetermined allowed temperature of the ceramic material.

FIG. 3 schematically show that the rotating die 3 comprises a pattern 38 comprising at least one indentation 38 in the lateral surface area 4. The number of indentations is here only an illustrative example and there may be more or less indentation or protrusions in a pattern spread over the rotating die 3 in a predetermined design depending on the desired features of the formed material. The indentations or protrusions can have any shape suitable, for example oval, round, polygon or a mixture of such or other shapes. The indentations 38 have a bottom 44 at a maximum depth of the indentation and the indentations may have different or similar depths. Between the indentations 38 the rotating die 3 comprises portions that have a default distance D2 between the rotating die 3 and the counter bearing 14 when facing the counter-bearing 14. It should be noted that any protrusion should not have a height larger than the default distance D2.

According to one example, the minimum distance D2 in the height direction Z between the lateral surface area 4 and the counter-bearing 14 is less than a maximum distance D1, i.e. the height of the passage 9.

In FIGS. 2 and 3 the channel 10 is formed between the lateral surface area 4 of a rotating die 3 and a counter-bearing 14 arranged opposite the rotating die 3. These two parts form the upper and bottom area of the channel 10. In order to define the channel laterally the channel 10 has side areas as well, thus closing the boundaries of the channel 10.

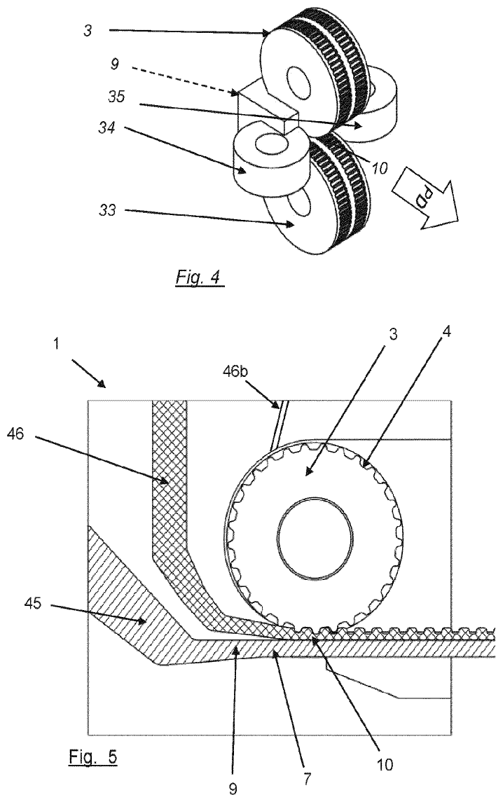

As seen in FIG. 4 it is possible to replace one or more of the static areas of the channel 10, i.e. the counter-bearing 14 and the side areas, by one or more additional rotating dies.

FIG. 4 schematically shows an assembly of rotary dies including four rotary dies. The channel 10 is here defined by the first rotating die 3, a second rotating die 33 arranged opposite the first rotating die 3 and replacing the counter-bearing 14, a third rotating die 34 replacing one of the side areas and a fourth rotating die 35 arranged opposite the third rotating die 34.

FIG. 4 is one example only. It would be possible to define the channel 10 by one more rotating dies 3, 33, 34, 35. For example, the channel 10 could be defined by two rotating dies 3, 33, 34, 35 while the remaining areas defining the channel 10 are static. As another example there is no need for the channel 10 to have a rectangular cross-section; the channel 10 could be defined by three areas forming a triangular cross-section, by six areas forming a hexagonal cross-section, etc. One or more, possibly all, areas of the channel 10 may be defined by a specific rotating die 3, 33, 34, 35. Each one of the rotating dies 3, 33, 34, 35 may have a specific pattern on its lateral surface area, for imprinting a side of the formed material with such pattern.

The second, third and/or the fourth rotating die(s) 33, 34, 35 can be arranged in a similar way as the above described first rotating die 3 to create same or different patterns on two sides of the formed material. The second, third and/or fourth rotating dies 33, 34, 35 can comprise annular recesses and/or flange portions that can be arranged to cooperate with annular recesses and/or flange portions of the first rotating die 3.

One or more of the rotating dies 3, 33, 34, 35 may be driven. According to one example, two or more rotating dies 3, 33, 34, 35 are synchronised. This has the advantage of feeding the ceramic material at the same speed through the channel 10. However, it could be possible to also use non-synchronous rotating dies 3, 33, 34, 35 in order to create friction and/or a special pattern and/or to compensate for material differences.

The extrusion device 1 can be arranged with a combination of textured and non-textured rotating dies 3, 33, 34, 35.

FIGS. 5-10 schematically show a co-extrusion device 1, and/or an on-extrusion device 1. Such extrusion device comprises an extrusion and/or pultrusion device 1, according to any one of the examples discussed above, wherein the device 1 comprises at least two inlet channels 45, 46, 47 that connects directly or indirectly to the channel 10. Each of the at least two inlet channels 45, 46, 47 is configured to feed one or more materials, at least one material being a ceramic material, at a predetermined distance upstream from the channel 10 or to a marriage point for the at least two inlet channels 45, 46, 47 in connection to where the passage 9 transitions into the channel 10.

Here, co-extrusion refers to where at least two material streams are together processed and formed into the master profile and then into the final profile or where the at least two material streams are together processed and formed into the final profile.

Here, on-extrusion refers to where the at least two material streams are positioned in a layered fashion either by being together processed and formed into the master profile and then into the final profile or by bringing together the at least two material streams into the master profile at the marriage point and thereafter together processing and forming the joint at least two material streams into the final profile in the channel 10.

FIG. 5 schematically shows a cross-sectional side view of an extrusion device 1. The profile definition zone 7 comprises a first inlet channel 45 in the form of the passage 9 and a second inlet channel 46 in the form of a second passage connected to the profile definition zone 7 upstream the channel 10. The second passage feeds an additional material to the channel 10 for forming a layered profile product 2 with ceramic material from the passage 9.

According to one example, the second passage 46 is an extrusion- or pultrusion channel similar to the passage 9 arranged to work the material. According to one example, the second passage 46 is a passage that is configured as a conveyer unit for conveying a material to the profile definition zone 7.

The device 1 further comprises an additional channel 46b arranged to guide a further material to ceramic material. Such channel 46b may be arranged to guide the further material to the lateral surface area 4 of the rotating die 3 upstream where the lateral surface area 4 defines the channel 10. As the rotating die 3 rotates, the lateral surface area 4 will carry the further material to the channel 10 where the further material is added to the ceramic material extrusion process. As one example, the further material may be a glazing material that distributes on the surface of the formed material.

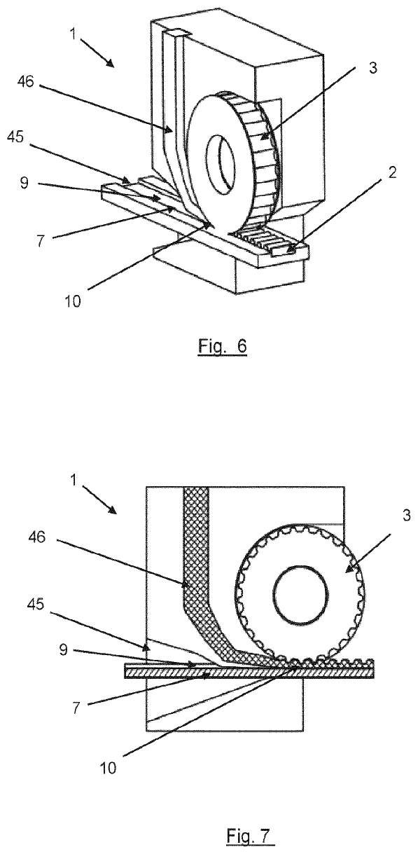

The same device 1 is shown schematically in FIGS. 6 and 7, however in these figures the additional channel 46b has been left out. As already explained, the device 1 comprises one rotating device 3 as described above and two material streams that are brought together via the passages 9, 46.

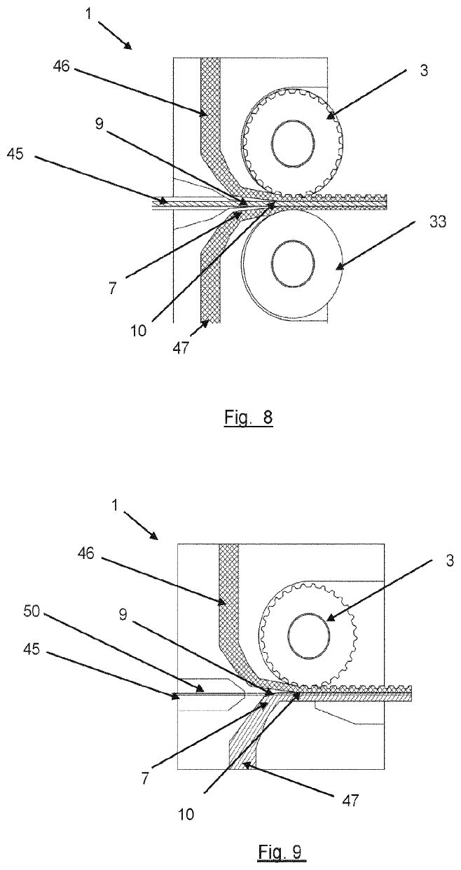

FIG. 8 schematically shows a cross-sectional side view of a device 1 comprising two opposing rotating dies 3, 33. FIG. 8 further shows that the device 1 comprises a passage 9 and a second passage 46 connected to the profile definition zone 7 upstream the channel 10 for feeding an additional material to the channel 10, thereby forming a layered profile product 2 with material from the passage 9. FIG. 8 further shows that the device 1 comprises a third passage 47 for feeding a third material to the profile definition zone 7.

According to one example, the third passage 47 is an extrusion- or pultrusion passage similar to the passage 9 arranged to work the material. According to one example, the passage 47 is a passage that is configured as a conveyer unit for conveying a material to the profile definition zone 7.

FIG. 9 schematically shows a cross-sectional side view of a device 1 that comprises one rotating die 3 and a three passages 9, 45, 46 for feeding three different materials to the profile definition zone 7 according to what is discussed in connection to FIG. 8.

FIG. 9 further shows an example where the passage 45 conveys a solid material 50, e.g. a wire, mesh, or the like, to the passage 9 and where the passages 46, 47 introduce one or more materials to be extruded or pultruded in the passage 9 and in the channel 10. The one or more materials may be layered onto the solid material 50 or may surround the solid material 50.

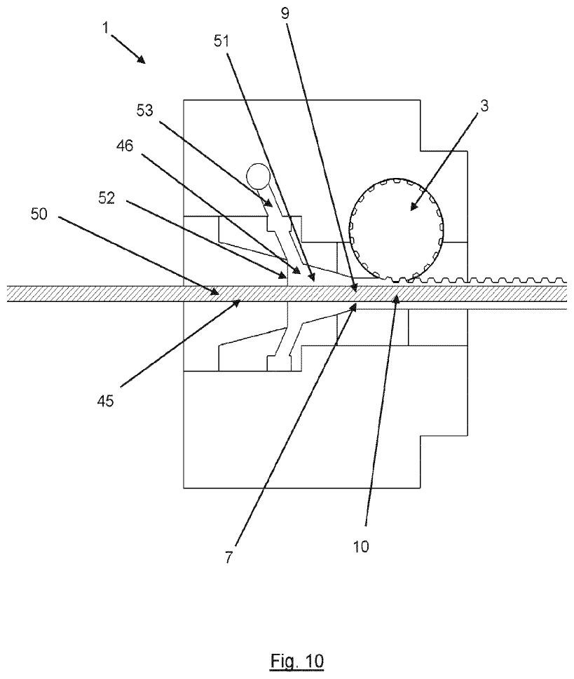

FIG. 10 schematically shows an example where the passage 45 conveys a continuous solid material 50 in the form of a wire, mesh, or the like, and a ceramic material to be extruded or pultruded in the passage 9 and channel 10. In FIG. 10 the passages 45, 46 are arranged such that the material from the passage 46 surrounds the solid material 50 and embeds the solid material 50. In FIG. 10, the passage 46 comprises a pressurized chamber 51 upstream the passage 9 for forming the ceramic material around the solid material 50. The pressurized chamber 51 comprises a back wall 52 delimiting the pressurized chamber 51.

The passage 46 comprises a feeding channel 53 to the pressurized chamber 51 for feeding the material to the chamber 51. The back wall 52 comprises the passage 45 that conveys the solid material 50 and acts as a stop for the ceramic material in the chamber to leak through the passage 45. Here, “pressurized” means that the ceramic material in the passage 46 is subject to pressure by the ceramic material being forced into the passage 46 and deformed in a similar way as described above with relation to the passage 9.

In FIG. 10 the passage 9 and channel 10 plastically deforms the material in a similar manner as described above. Plastic deformation may take place also in the pressurized chamber 51, but is not limited to such deformation. Hence, the material in the pressurized chamber 51 may be formed to surround the solid material 50 without being plastically deformed.

Here, “solid material” refers to a material that does not undergo any deformation in the profile definition zone 7. A non-exhaustive list of examples of solid materials are; bendable wire, stiff rod-like element, mesh of metal and/or fabric and/or composite and/or other suitable materials, a combination of such solid materials, etc.

With reference to FIGS. 5 to 10, the different materials are brought together before the channel 10 and is then worked in the channel 10 as described above. The invention is not limited to three passages 9, 45, 46, 47 but further passages are possible in order to produce a ceramic product with same or different materials in different layers.

According to any one of the preceding examples, the ceramic material that is fed into the device 1 to form the final ceramic product is either one homogenous material or a mixture of two or more materials that are blended and or layered. The materials can be blended in different ratios and may be blended into a homogeneous mix or a mix with gradients within the material. One material can be a solid and another material can be moldable, e.g. stone bits and clay, wherein the clay forms the ceramic material. The material can also be a layered material comprising two or more layers of same or different materials. The material may comprise one or more strings of solid material that follow through the entire extrusion or pultrusion process, e.g. a wire or another reinforcement material being surrounded by the deformable material. It is also possible to use fibers are reinforcement material.

According to one example, the maximum allowable pressure applied by the rotating die 3 at the position of the minimum distance D2 is dependent on friction between the ceramic material and the counter bearing 14 in the channel 10.

According to one example, the device 1 is configured to feed a friction material between the counter-bearing 14 and the formed material and/or configured to feed a friction material between the rotating die 3 and the formed material.

According to one example, the friction material is conveyed by any of the passages 45, 46, 47 at least during start-up of the device 1 in order to control friction in connection to the rotating die 3 and/or the counter bearing 14.

According to one example, the friction material is conveyed by any of the passages 45, 46, 47 during a part of or during the entire production process in order to control friction in connection to the rotating die 3 and/or the counter bearing 14.

According to one example, the friction material is fed directly to the rotating die 3 such that the friction material rotates with the rotating die 3 from a position upstream the channel 10. A friction material feeding device can be either one of the passages 45, 46, 47. Furthermore, the friction material may be a solid material, a liquid or a gas, or a combination thereof.

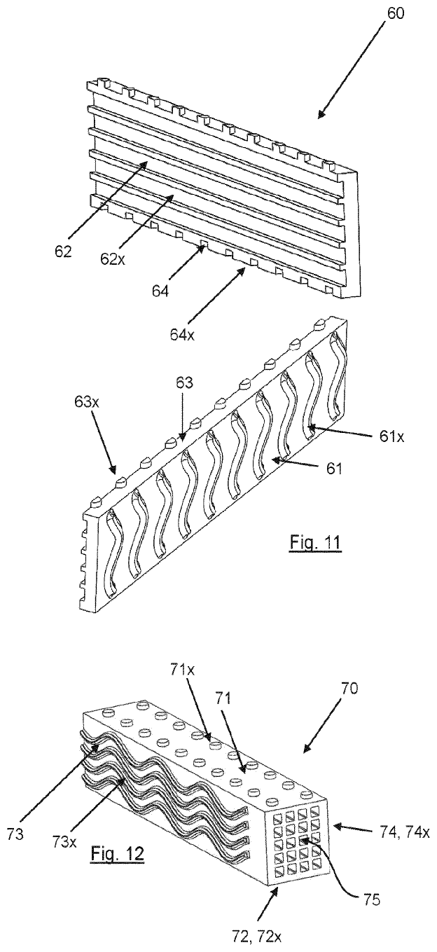

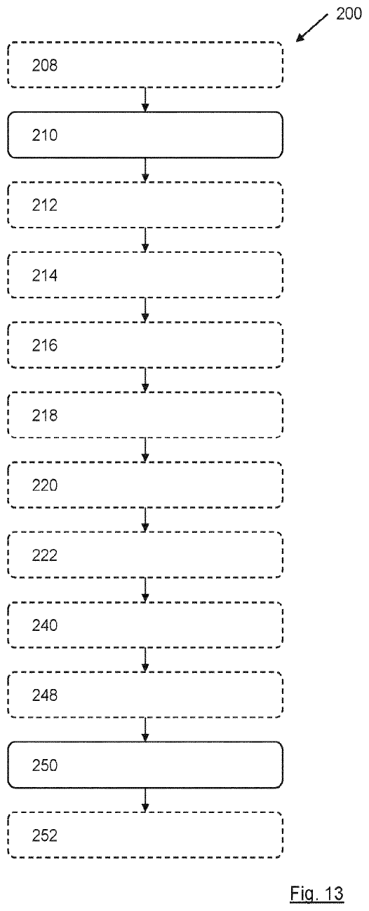

Now turning to FIGS. 11 and 12 some examples of ceramic products being manufactured by a method according to an embodiment will be described.

Generally, the present invention allows for a continuous forming of ceramic material which, upon suitable heat processing, forms ceramic products. Most preferably the methods described herein are used to produce a continuous profile of formed material, which is subjected to a separation action, such as cutting, in order to form a series of identical or at least similar products. For example, the method may produce a profile which is cut at specific positions to produce products of that specific length, while another portion of the profile is cut at other positions to produce products of a different length. Such products are consequently not identical, but similar as they are cut from the same profile.

The ceramic products shown in FIGS. 11 and 12 are subjected to heat processing. Hence, these illustrations also represent the shape of the formed material, at least after being separated from the continuous profile exiting the extrusion device 1.

FIG. 11 shows a plate-like ceramic product 60 produced by forming a ceramic material using at least one rotating die 3, and subsequent heat processing. The ceramic product 60 has an upper side 61, a bottom side 62, and two opposite sides 63, 64. Each side 61-64 is provided with a repetitive pattern 61x, 62x, 63x, 64x formed by an associated rotating die 3, 33, 34, 35. In order to produce the ceramic product 60, it is thus necessary to make use of four rotating dies 3, 33, 34, 35 in line with the example shown in FIG. 4.

The pattern 61x of the upper side 61 comprises parallel transverse wave-like protrusions, formed by corresponding depressions of the rotating die 3. The pattern 62x of the bottom side 62 comprises parallel longitudinal grooves, formed by correspond protrusions of the rotating die 33. A first side 63 comprises a pattern 63x of equally spaced-apart protrusions, and the opposite side 63 comprises a pattern 64x of equally spaced-apart depressions. The patterns 63x, 64x of the opposing sides are matching, such that the protrusions of pattern 63x fit in the depressions of pattern 64x.

Hence, the ceramic product 60 can be used in an assembly requiring several ceramic products 60, as the fit of the sides 63, 64 makes it very easy to fit multiple products 60 to each other. For example, the ceramic product 60 may be a floor tile where the pattern 61x of the upper side 61 provides an anti-slip surface.

Another example of a ceramic product 70 is shown in FIG. 12. Here the ceramic product 70 is brick-like rather than plate-like, but produced in a similar way by forming a ceramic material using at least one rotating die 3, and subsequent heat processing.

The ceramic product 70 has an upper side 71, a bottom side 72, and two opposite sides 73, 74. Each side 71-74 may be provided with a repetitive pattern 71x, 72x, 73x, 74x formed by an associated rotating die 3, 33, 34, 35. In order to produce the ceramic product 70, it is thus necessary to make use of four rotating dies 3, 33, 34, 35 in line with the example shown in FIG. 4.

The pattern 71x of the upper side 71 comprises repetitive protrusions, arranged in rows and columns and being formed by corresponding depressions of the rotating die 3. The pattern 72x of the bottom side 72 may be entirely planar, or it may comprise recesses matching the protrusions of the upper side 71.

A first side 73 comprises a pattern 73x of parallel wave-like protrusions, and the opposite side 73 may be entirely planar of comprise a pattern 74x of any protruding or depressed kind.

The ceramic product 70 can be used in an assembly requiring several ceramic products 70, as the fit of the sides 71, 72 makes it very easy to fit multiple products 70 onto each other. For example, the ceramic product 70 may be a brick where the pattern 73x of the side 71 provides improved aesthetics to the resulting construction.

The ceramic product 70 is partially hollow, as a result of multiple channels 75 extending through the entire ceramic product 70 in the longitudinal direction.

According to the above description, a ceramic product 60, 70 is formed by pressing or pulling ceramic material through a channel at least partly defined by at least one rotating die, and subsequent heat processing to form the ceramic product.

Examples of ceramic products are brick or a plate-like products such as a tile or cladding.

For improving usability of the ceramic products, each or any side of the ceramic product may be provided with a contour which matches with a corresponding contour of a side of another ceramic product. This means that two or more ceramic products 60, 70 may be joined in a puzzle-like manner, providing new and improved ways of aligning and fitting ceramic products to each other as well as to adjoining structures.

Due to the versatility of the rotating die 3, the ceramic products may comprise a structural surface pattern corresponding to a pattern of the rotating die.

Typically, the structural surface pattern is provided on an upper side of the ceramic product 60, 70 during its intended use, and/or on a bottom side of the ceramic product 60, 70 during its intended use.

As described above the structural surface pattern on the bottom side 60, 70 of the ceramic product can form mounting structures for the ceramic product. For example, the ceramic product may be a façade tile or cladding wherein hangers are integrally formed on the bottom side of the ceramic product already during the extrusion process using a rotating die 33 acting on the underside of the formed material.

A ceramic product 60, 70 may be included in different types of devices. For example, a ceramic product 60, 70 may form part of a thermal device such as a heat exchanger, cooling profile, and/or heat element. For example, a ceramic product 60, 70 may form part of a chemical reactor such as a catalyser or a condenser. For example, a ceramic product 60, 70 may form part of an anti-slip device, such as forming a surface of said anti-slip device.

Now turning to FIG. 13, a method 200 for manufacturing a ceramic product 60, 70 will be explained further. In general, the method 200 comprises two main steps 210, 250, and a number of optional step (marked with dashed lines in FIG. 13) which may be performed in accordance with specific embodiments.

Most generally, the method 200 comprises a step 210 of forming material by pressing or pulling ceramic material through a channel 10 of an extrusion device 1, where the channel 10 is at least partly defined by the lateral surface area 4 of at least one rotating die 1. In a subsequent step 250, the formed material is heat processed to form a ceramic product.

As explained above, the rotating die 3 is preferably applying a pattern, which may be repetitive, to the formed material.

Depending on the type of ceramic material used for the method, the method 200 may further comprise a step 252 of shrinking the formed material such that the dimensions of the pattern of the rotating die 3 are different from the dimensions of the pattern of the ceramic product 60, 70. Preferably, shrinking is caused after the step of forming the material, preferably during heat processing of the formed material.

During operation of the extrusion device 1, the method may perform a step 208 of adjusting the flow of the ceramic material upstream the channel 10, and/or a step 212 of driving the rotating die 3. Step 212 is preferably performed such the rotation of the rotating die 3 is synchronized with the speed of a downstream conveyor for the ceramic product.

Another optional step 214 can be performed, during which at least one dimension of the ceramic product is determined, and the speed of the rotating die 3 and/or the downstream conveyor is adjusted based on the determined dimension(s).

The step 250 of heat processing may be performed in one or more sub-steps. For example, the step may comprise firing the ceramic material, but it may also comprises an initial drying step. Typically, the drying step may be performed at room temperature or at a relatively modest temperature, while firing is performed using much higher temperatures (such as 800-1500° C.). As is readily understood, the exact design of the heat processing step 250 must be selected based on the ceramic material used, as well as on the desired properties of the final ceramic product.

Another optional step 240 of separating an individual product from the formed material may be performed either before, during, or after the step 250 of heat processing. Optionally, a step 248 may be performed in which a plurality of individual products are mounted to each other before the step 250 of heat processing.

Step 240 may be performed by a cutting action of the rotating die 3, or by using a separate cutting station.

The method 200 may further comprise a step 216 of adding a further material to the ceramic material. Step 216 may be performed before, during, or after the ceramic material passes the rotating die 3.

The further material is e.g. embedded in the ceramic material to form a reinforcement of the ceramic product. The further material may be a fibre material or a web material. The further material may be added as at least one layer to the ceramic material. The further material may be a liquid or a solid material in the form or powder or particles. The further material may comprise a plurality of different ceramic and/or non-ceramic materials.

Step 216 may be performed by feeding the ceramic material and the at least one further material through the channel.

The method 200 may further comprise a step 218 of adjusting the position of the rotating die 3 thereby adjusting the dimensions of the channel 10, and consequently also the dimensions of the ceramic product. This step 218 may be performed by altering the position of the rotating die 3 relative the other areas of the channel 10, may they be defined by static bearing-surfaces or other rotating dies. Optionally, step 218 is performed by arranging the rotational axis of the rotating die 3 at an angle relative to the production direction, preferably the rotating die is arranged at an angle of 90°+25° relative to said production direction.

An optional step 220 may also be performed, which comprises providing the channel 10 with at least one die core, said die core forming a hollow portion 75 of said ceramic product 60, 70.

A step 222 may be further performed in which the channel 10 provides one side of the formed material with a first structural surface pattern defined by the lateral surface area of at least one rotating die 3, and an opposite side of the formed material with a second structural surface pattern defined by the lateral surface area of another rotating die 33, 34, 35. Possibly, the first and second structural surface patterns will provide a matching fit when multiple ceramic products are stacked onto each other.

It should be noted while the method 200 has been described as a series of performed steps, these steps could be performed in any suitable order, or even simultaneously. Especially the extrusion part of the method 200 is preferably performed continuously, which means that many of the above-described steps are performed at the same time and repeatedly.

To summarize, the present disclosure presents improved methods for processing ceramic material in order to form ceramic products. The ceramic material is fed through a passage 9 where it is formed into a master profile 36, and feeding the ceramic material further to a channel defined at least partly by at least one rotating die 3, where the master profile 37 transforms into a final profile 37. By heat processing the final profile 37 is transformed to a ceramic product 60, 70.

From the description above follows that, although various embodiments of the invention have been described and shown, the invention is not restricted thereto, but may also be embodied in other ways within the scope of the subject-matter defined in the following claims.

1. A production method, comprising:
forming material by pressing or pulling ceramic material through bearing surfaces defining a channel of an extrusion die, said bearing surfaces comprising at least one rotating bearing surface being a surface of a rotating die that defines the cross-section of the formed material such that said channel being at least partly defined by the lateral surface area of at least one rotating die, and
heat processing the formed material to form a ceramic product.

2. The method according to claim 1, wherein the rotating die is applying a pattern to the formed material.

3. The method according to claim 2, wherein the rotating die is applying a repetitive pattern to the formed material.

4. The method according to claim 2, further comprising shrinking the formed material such that the dimensions of the pattern of the rotating die are different from the dimensions of the pattern of the ceramic product.

5. The method according to claim 4, wherein shrinking is caused after the step of forming the material, preferably during heat processing of the formed material.

6. The method according to claim 1, further comprising adjusting the flow of the ceramic material upstream the channel.

7. The method according to claim 1, further comprising driving said rotating die.

8. The method according to claim 7, wherein driving the rotating die further comprising synchronizing the rotation of the rotating die with the speed of a downstream conveyor for the ceramic product.

9. The method according to claim 7, further comprising determining at least one dimension of the ceramic product, and adjusting speed of the rotating die and/or the downstream conveyor based on the determined dimension(s).

10. The method according to claim 1, wherein heat processing is performed by firing the formed material.

11. The method according to claim 1, further comprising separating an individual product from the formed material before, during, or after heat processing.

12. The method according to claim 11, further comprising mounting a plurality of individual products to each other before the step of heat processing.

13. The method according to claim 11, wherein separating an individual product is performed by a cutting action of the rotating die.

14. The method according to claim 11, wherein the circumference of the rotating die is equal to the length of the individual product.

15. The method according to claim 11, wherein the circumference of the rotating die is different from the length of the individual product.

16. The method according to claim 1, wherein the channel has a longitudinal extension in a production direction, and wherein the rotational axis of the rotating die is arranged at an angle relative to said production direction, preferably the rotating die is arranged at an angle of 90°±25° relative to said production direction.

17. The method according to claim 1, wherein the channel is defined by a bottom area, an upper area, and two opposing side areas together forming a closed space, wherein at least a part of one of the areas is formed by the lateral surface area of the at least one rotating die.

18. The method according to claim 17, wherein at least a part of at least one further area is defined by the lateral surface area of a further rotating die.

19. The method according to claim 17, wherein at least one of the bottom area, upper area, and the two opposing side areas is defined by a bearing surface.

20. The method according to claim 1, further comprising pressing or pulling ceramic material through a pre-bearing passage arranged upstream the rotating die.

21. The method according to claim 20, wherein the pre-bearing passage is arranged immediately upstream the rotating die.

22. The method according to claim 20, wherein the pre-bearing passage is arranged upstream, but remote from, the rotating die.

23. The method according to claim 20, wherein the pre-bearing passage is configured to deform the ceramic material into a master profile, while the channel is configured to further deform the ceramic material into a final profile.

24. The method according to claim 20, wherein the dimensions of the pre-bearing passage are static.

25. The method according to claim 1, wherein the lateral surface area of the rotating die is provided with a topographic pattern.

26. The method according to claim 25, wherein said topographic pattern comprises at least one protrusion, said protrusion being configured to form a separation notch in the ceramic product and/or a significant local reduction of the thickness of the ceramic product.

27. The method according to claim 26, wherein the significant reduction of the thickness of the ceramic product defines a removable portion of the ceramic product.

28. The method according to claim 26, wherein the at least one protrusion extends across the entire width of the rotating die, or across a part of the width of the rotating die.

29. The method according to claim 26, wherein said protrusion extends in a linear or curved manner across the width of the rotating die.

30. The method according to claim 1, further comprising adding a further material to the ceramic material.

31. The method according to claim 30, wherein adding the further material is performed before, during, or after the ceramic material passes the rotating die.

32. The method according to claim 30, wherein the further material is embedded in the ceramic material to form a reinforcement of the ceramic product.

33. The method according to claim 32, wherein the further material is a fibre material or a web material.

34. The method according to claim 30, wherein the further material is added as at least one layer to the ceramic material.

35. The method according to claim 34, wherein the further material is a liquid or a solid material in the form of powder or particles.

36. The method according to claim 30, wherein the further material comprises a plurality of different ceramic and/or non-ceramic materials.

37. The method according to claim 27, wherein the ceramic material and the at least one further material is fed through the channel.

38. The method according to claim 1, further comprising adjusting the position of the rotating die thereby adjusting the dimensions of the channel.

39. The method according to claim 1, further comprising providing the channel with at least one die core, said die core forming a hollow portion of said ceramic product.

40. The method according to claim 1, wherein the ceramic product is a brick or a plate-like product such as a tile.

41. The method according to claim 1, wherein the channel provides one side of the formed material with a first structural surface pattern defined by the lateral surface area of at least one rotating die, and an opposite side of the formed material with a second structural surface pattern defined by the lateral surface area of another rotating die.

42. The method according to claim 41, wherein the first and second structural surface patterns will provide a matching fit when multiple ceramic products are stacked onto each other.

43. A ceramic product formed by forming ceramic material by pressing or pulling the ceramic material through bearing surfaces defining a channel of an extrusion die, said bearing surfaces comprising at least one rotating bearing surface being a surface of a rotating die that defines the cross-section of the formed material such that said channel being at least partly defined by at least one rotating die, and subsequent heat processing to form the ceramic product.

44. The ceramic product according to claim 43, wherein the ceramic product is a brick or a plate-like product such as a tile or cladding.

45. The ceramic product according to claim 43, said ceramic product comprising a plurality of sides, wherein each side is provided with a contour which matches with a corresponding contour of a side of another ceramic product.

46. The ceramic product according to claim 43, comprising a structural surface pattern corresponding to a pattern of the rotating die.

47. The ceramic product according to claim 46, wherein the structural surface pattern is provided on an upper side of the ceramic product during its intended use.

48. The ceramic product according to claim 47, further comprising a structural surface pattern on a bottom side of the ceramic product during its intended use.

49. The ceramic product according to claim 48, wherein the structural surface pattern on the bottom side of the ceramic product forms mounting structures for the ceramic product.

50. The ceramic product according to claim 48, whereby the respective structural surface patterns will provide a fit when multiple ceramic products are stacked onto each other.

51. The ceramic product according to claim 43, comprising at least one further material.

52. A device, comprising at least one ceramic product according to claim 43.

53. The device according to claim 52, being a thermal device and wherein the ceramic product forms part of a heat exchanger, cooling profile, and/or heat element.

54. The device according to claim 52, being a chemical reactor and wherein the ceramic product forms part of a catalyser or a condenser.

55. The device according to claim 52, being an anti-slip device and wherein the ceramic product forms a surface of said anti-slip device.
